(19) United States
(12) Patent Application Publication
(10) Pub. No.: US 2002/0083321 A1
(43) Pub. Date: Jun. 27, 2002

(54) Distributed digital television system and related method

(76) Inventor: Michael D. James, Hamble (GB)

Correspondence Address: Corporate Patent Counsel, U.S. Philips Corporation, 580 White Plains Road, Tarrytown, NY, 10591, US

(21) Appl. No.: 10/022,168

(22) Filed: Dec. 13, 2001

(30) Foreign Application Priority Data
Dec. 22, 2000 (GB) 0031437.7

(51) Int. Cl. H04L 9/00

(52) U.S. Cl. 713/168

(57) ABSTRACT

The invention provided for a distributed digital television system (52) comprising a plurality of discrete television sets (54, 56, 58) and means for decoding digital television signals for display at the television sets (54, 56, 58) wherein the said means for decoding comprises a respective plurality of distributed signal decoding arrangements (62, 66, 72) and further includes means (78, 86) for transferring decoding authorization data over a network (86) linking the said plurality of television sets (54, 56, 58) in the system and from a digital decoding arrangement (62, 66, 72) associated with one television set (54, 56, 58) to a digital decoding arrangement (62, 66, 72) associated with another television set (54, 56, 58).

### FIELD OF INVENTION

The present invention relates to a distributed digital television system comprising a plurality of discrete television sets and means for decoding digital television signals for display at the television sets.

### BACKGROUND OF INVENTION

Currently available television systems employing a plurality of television sets, particularly those for the domestic market, generally employ a single antenna arranged to deliver the received television signals to a signal splitter. The signal splitter serves to provide a plurality of output signals to a respective plurality of discrete television sets positioned at appropriate locations around, for example, a residential dwelling.

With analogue television reception systems, each television set is equally capable of receiving the same, or different, program information and all the television sets and their associated receivers tend to contain identical hardware functionality.

While such distributed television systems are becoming increasingly popular, particularly as the number of households having more than one television set increases, so to is the popularity of digital television. Thus, the provision of, for example, a domestic distributed digital television system mirroring the full functionality of currently available analogue systems is naturally desirous.

One of the main perceived advantages in employing a digital television reception system is that, in addition to enhanced picture quality and choice of channels/programs, features enhancing the security with which predetermined channels and/or programs can be successfully received and viewed can readily be incorporated into the system.

Currently, digital television provides three basic levels of security. First, uninscripted, or “open” transmissions are available, in which the data content is not modified in any way to enhance security aspects and can simply be decoded by means of an appropriate digital segment decoder without the requirement of any additional level of signal deciphering, such as by way of a cryptographic engine. Secondly, there is provided so-called encrypted “free-to-air” transmissions in which the data content is encrypted but wherein the decryption key is readily available to the decoder hardware in such a manner so as to allow for decoding and deciphering of the data content as long as the receiver contains the appropriate cryptographic engine.

Finally, there is the highest level of security provided by means of so-called encrypted “pay” transmissions in which, in addition to the data content being encrypted, the decryption key is made available only on a restricted basis for the specific cryptographic engines, so that only conditional access to predetermined channels/programs is available.

U.S. Pat. No. 5,936,660 discloses a digital video conversion system of the above-mentioned type for domestic use in which multiple converter chains for signals providing for conditional access to certain channels/programs are housed in close proximity within a single chassis which then connects to the plurality of televisions defining the domestic system.

Such an arrangement is however disadvantageous in that the unitary mounting of the cryptographic engines within a common chassis provides limited security against abuse of the system and also requires manual presence at the chassis should any reconfiguring of the system be required.

### OBJECT OF INVENTION

The present invention seeks to provide for a distributed digital television system and related method having an advantage over known such systems and methods.

### SUMMARY OF INVENTION

According to one aspect of the present invention, there is provided a distributed digital television system of the above-mentioned type characterised in that the said means for decoding comprises a respective plurality of digital decoding arrangements, and further includes means for transferring decoding authorization data over a network linking the said plurality of televisions in the system and from a digital decoding arrangement associated with one television set to a digital decoding arrangement associated with another television set within said plurality of television sets.

The invention is particularly advantageous in readily allowing for access to restricted television signals on any of a plurality of television sets within a local television network.

The feature of claim 2 advantageously provides for a particularly efficient and effective means for the control transfer of decoding authorization data.

The feature of claim 3 further enhances the adaptability of the present invention to features arising in relation to standard television signals distribution systems.

The feature of claim 4 is advantageous in providing for a specific layer of security with regard to the distribution of the decoding authorization data itself.

The features of claim 5 and 6 prove particularly advantageous in defining nodes within the network to which, and from which, the digital television signals and also decoding authorization data can be transmitted.

### BRIEF DESCRIPTION OF DRAWINGS

The invention is described further hereinafter, by way of example only, with reference to the accompanying drawings in which:

FIG. 1 is a schematic block diagram of an analogue domestic TV reception system as currently known;

FIG. 2 is a schematic block diagram of a standard digital TV receiver as currently known;

FIG. 3 is a schematic representation of a local network of TV receivers allowing for secure transmission of key authentication requests according to an embodiment of the present invention;

FIG. 4 is a schematic block diagram of a digital TV receiver adapted for use in accordance with an embodiment of the present invention; and

FIG. 5 is a schematic representation illustrating a distributed digital television system embodying the present invention.

### DETAILED DESCRIPTION

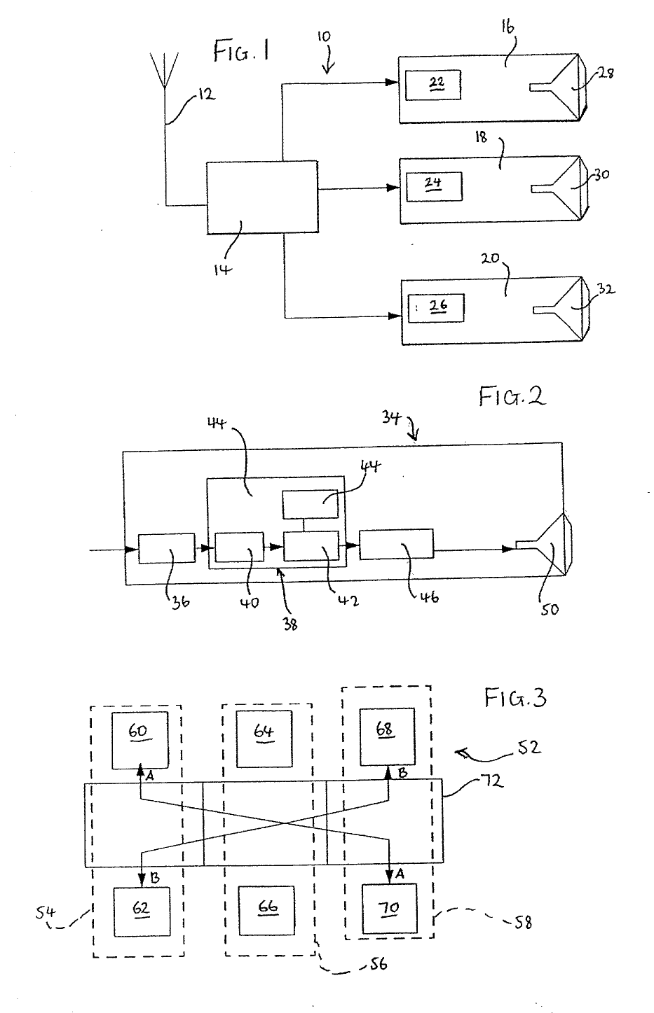

Turning first to FIG. 1, there is illustrated a schematic representation of an analogue domestic TV reception system 10 as currently known in the art and employing a single antenna 12 receiving analogue television signals and delivering the same to a signal splitter 14 which divides the signal for onward transmission to three discrete television sets 16, 18, 20 each including respective receiver hardware 22, 24, 26 and display hardware 28, 30, 32.

As will be appreciated, each analogue television set 16, 18, 20 is equally capable of receiving any one of the analogue signals received at the antenna 12 such that the reception behaviour of the system 10 allows for maximum viewing choice at each of the respective displays 28, 30 and 32.

It is the ready provision of such a choice of display at each of a plurality of a digital television sets provided a distributed network that is at the heart of the present invention.

With regard to FIG. 2, there is illustrated a block diagram of a digital television set 34 as currently known in the art. The digital television set 34 comprises a receiving unit 36 for receiving incoming digital TV signals which are then delivered to a smart card module 38 comprising, in series, a demultiplexer 40 for receiving and separating signals from the incoming digital signal received at the receiver 36, and a deciphering unit 42 in the form of a cryptographic engine which operates, under a control of decoding authorization data such as cryptographic key information 44, so as to decipher the coded signals output from the multiplexer 40.

The deciphered signal is then delivered to a decoder 46, for example in the form of an MPEG decoder which serves to reconstruct the decompressed data for subsequent display at a display unit 50 of the digital television set 34. As will be appreciated, it is within the smart card module 38 that encrypted “paid” transmissions are deciphered under the selective control of the cryptographic key 44 so as to control the programs/channels that can actually be viewed at the display 50 of the digital television set 34.

The present invention is concerned with a network arrangement whereby decoding authorization data in the form of cryptographic key information can itself be transferred between smart card modules associated with different digital television receivers. This allows for an efficient, but secure, means for enhancing the manner in which a distributed television system can allow for the viewing of any particular authorised program/channel at any one of the distributed television sets.

As will be appreciated with the basic prior art digital television set of FIG. 2, a specific problem arises from a users point of view when they wish to view a secure broadcast on a different receiver from the one which contains the smart card module with the key information for that specific secure “paid” broadcast. The user would then be required to swap the physical modules and this is generally inappropriate, inconvenient, and time consuming.

FIG. 3 provides a schematic representation of a plurality of digital television sets of a distributed television system according to an embodiment of the present invention and which is arranged to readily overcome such disadvantages.

FIG. 3 illustrates a distributed digital television system 52 connected as a network and which is formed of three digital television sets 54, 56, 58. Digital television set 54 contains a smart card module comprising cryptographic key data 60 and a cryptographic engine 62, whereas the digital television set 56 contains a smart card module including cryptographic key data 64 and a cryptographic engine 66, whereas digital television set 58 includes a smart card module comprising cryptographic key data 68 and a cryptographic engine 70.

In the illustrated example, the cryptographic key information 60 primarily associated with digital television set 54 is arranged to provide for encrypted “paid” transmissions in which the cryptographic key data is required to allow for the authorised viewing of predetermined television channels/programs. The smart card module of television set 56 is arranged such that the smart card data 64 located therein is arranged to service unencrypted “open” transmissions in which data content is not modified in any particular controlled manner and in which standard decoding is required. However, the cryptographic key data 68 of digital television set 58 is arranged to provide for decryption of “free-to-air” transmissions in which, although the data content is encrypted, the decryption key is generally known and available in an unrestricted manner.

Also illustrated in FIG. 3 is a signal distribution network 72 that serves to link the distributed digital television sets of the system 52 and which is advantageously arranged to provide for secure transmission of the decoding authorization date and in general provide for a two-way data transfer between the cryptographic engines of one television set and smart card modules of in other television set. The data exchange provided by the local network 72 is advantageously achieved via a network formed by standard radio frequency feeder cables that exist within known television distribution systems. The use of a single signal distribution network 72 can therefore advantageously be provided between receivers in a domestic environment and, to further illustrate this example, the frequency spectrum below 50 MHz can advantageously be employed for the transfer of decoding authorization data since such spectrum is not otherwise employed in a VHF/UHF television distribution system.

As already mentioned, the local network 72 arranged for the transfer of cryptographic key information can also be enhanced by a separate additional layer of cryptography so as to add an additional layer of security into a network embodying with the present invention.

In the illustrated example, arrows A and B illustrate the manner in which decoding authorization data is transferred between the television sets 54, 56, 58 within a system embodying the present invention. A particular situation is illustrated in which the decoding authorization data associated with television set 54 can in fact be transferred for operation in association with the cryptographic engine 70 located within the television set 58, whereas the decoding authorization data arising in relation to the smart card module 68 of television set 58 can itself be transferred for operation in association with the cryptographic engine 62 associated with television set 54.

In this manner, the television program/channel requiring specific authorization for viewing can be selectively made available at more than one television set within the system and, in the example illustrated in FIG. 3, such channel/program is being made available at television set 58.

Thus, it should be appreciated that the present invention advantageously provides for the exchange of decoding authorization data via a network linking distributed digital television sets within the system such that the decoding authorization data can effectively be shared around the digital television sets within the system so that a user can readily select, in a secure and efficient manner, at which of the television sets a specific secured channel/program broadcast is to be viewed.

The system as illustrated with regard to FIG. 3 is further advantageous in that it can restrict the display of the protected program/channel to one television set only and so serves to prevent undesired multiple viewing of the protected program/channel.

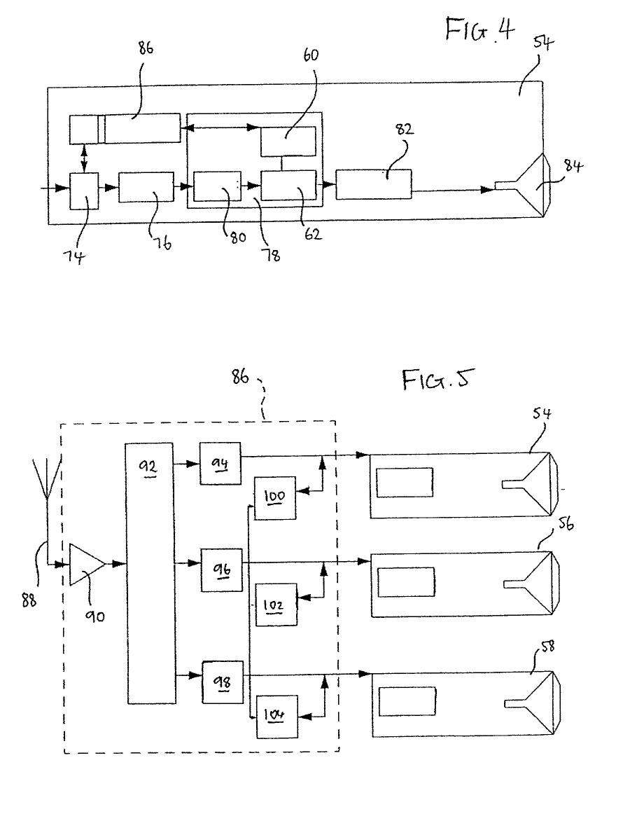

Turning now to FIG. 4, there is illustrated a television set 54 of a distributed digital television system such as that illustrated in FIG. 3, and where appropriate, the same reference numerals are employed.

The television set 54 for use in accordance with an embodiment of the present invention comprises a signal receiver arrangement including a demultiplexer 74 serving to split the incoming signal between the digital television signal and the decoding authorization data in the form of the cryptographic key data for use within the smart card module 78. The digital television signals output to the demultiplexer 74 are delivered to a receiver unit 76 and then passed to the smart card module 78 including, in the series, a demultiplexer 80 for dividing the digital television signals into separate signals and a cryptographic engine for deciphering the received coded signals in accordance with the cryptographic key data 60. As with the standard digital television receiver illustrated in FIG. 2, the signal output from the cryptographic engine 62 is delivered to an MPEG decoder 82 for decompressing the signal for subsequent display at the display unit 84.

As will be appreciated, the cryptographic key information 60 serves to determine the manner in which the cryptographic engine 62 processes and deciphers the digital television signal output from the demultiplexer 80 can comprise locally generated key data or, alternatively, key data having been delivered via a radio frequency LAN interface 86 which itself has retrieved the decoding authorization data from the incoming signal at the demultiplexer 74.

The smart card module 78 also includes within the cryptographic key handling arrangement 60 key management hardware which is arranged to communicate with other receivers within the domestic distributed television system. The demultiplexer 74 also has a multiplexing function allowing the key management hardware to communicate with other receivers in the household via, for example, the radio frequency LAN established between the television sets.

As will be appreciated, in accordance with the currently described embodiment, the only modifications required to known domestic television distribution systems need only be incorporated in the television receivers and the signal splifters present within the household. Currently existing coaxial cable can be used to provide for a secure local network required in accordance with a particular advantageous embodiment of the present invention.

Turning now to FIG. 5, there is provided a schematic block diagram illustrating a system according to an embodiment of the present invention and which illustrates a distributed digital television system employing three television sets each similar to that illustrated with reference to FIG. 4.

Thus, FIG. 5 illustrates three distributed digital television sets 54, 56, 58 which are connected by means of a local area network 86 which is itself arranged to receive digital television signals from an antenna 88. Signals received at the antenna 88 are delivered to an isolation amplifier 90 the output of which is connected to a signal splitter 92 for dividing the incoming digital television signals into three separate signals. Each of these three separate signals is intended for receipt at each of the three respective television sets 54, 56, 58 and so each can be transmitted to the respective television sets by means of respective high pass filters 94, 96, 98 which form part of a filtering arrangement of the network serving to allow for communication between the cryptographic key management hardware associated with each television set.

As mentioned previously, according to one embodiment of the present invention, the decoding authorization data can be transferred between discrete television sets within the television system through employment of the frequency below 50 MHz not otherwise used in a VHF/UHF TV distribution system. Thus, the network providing for the transfer of the decoding authorization data amongst the television sets 54-58 employs respective low pass filters 100, 102, 104 which, in combination with the high pass filters 94, 96, 98 as previously mentioned, serves to restrict the transfer of the decoding authorization data to the network linking the discrete television sets 54, 56, 58.

Thus, it should therefore be appreciated that there has been proposed a distributed television system which, in an efficient and secure manner, can achieve reception behaviour within the system that is at least approximately equivalent to currently known analogue reception systems such as that illustrated in FIG. 1.

It should however be appreciated that the invention is not restricted to the details of the foregoing embodiments. For example, as an alternative, a system such as a Bluetooth (a trademark of Telefonaktiebolaget LM Ericsson, Sweden ) wireless LAN could be used. However, the security aspects of such a system might not be seen to be as advantageous as that illustrated above since one particular feature arises with regard to the need for all television receivers to be connected to a common television signal distribution point. Further, in addition to, for example, cryptographic key data exchange, a radio frequency distribution network could also be employed to carry Internet data to and from the television sets connected within a distributed system.

1. A distributed digital television system comprising a plurality of discrete television sets and means for decoding digital television signals for display at the television sets, characterised in that the said means for decoding comprises a respective plurality of distributed signal decoding arrangements and further includes means for transferring decoding authorization data over a network linking the said plurality of television sets in the system and from a digital decoding arrangement associated with one television set to a digital decoding arrangement associated with another television set.

2. A system as claimed in claim 1, wherein the said network comprises a television signal distribution network for delivering digital television signals to the television sets.

3. A system as claimed in claim 1 wherein said network is formed by a radio frequency feeder cables of the distribution system.

4. A system as claimed in claim 1 and arranged such that the decoding authorization data is arranged to be transferred between the television sets under a separate cryptographic layer of security.

5. A system as claimed in claim 1 wherein each television set includes a respective digital decoding arrangement.

6. A system as claimed in claims 1 wherein the digital decoding arrangement is arranged to receive coded digital television signals and to input and output decoding authorization data for the authorization of the decoding of digital television signals either locally within the television set or remotely at another television set within the system.

7. A system as claimed in claim 1 wherein the decoding authorization data comprises a cryptographic key information.

8. Digital television apparatus including a digital signal decoding arrangement for receiving coded digital television signals and means for the input and output of decoding authorization data serving to control the decoding of the digital television signal either locally within the apparatus or remotely at further digital television apparatus.

9. An apparatus as claimed in claim 8, and comprising a paired television set and digital decoding arrangement including demultiplexing means for splitting decoding authorization data from a received digital television signal.

10. A method of controlling the distribution of digital television signals within a digital television system comprising a plurality of discrete television sets, including the steps of decoding the digital television signals for display at the television sets and characterized by the steps of decoding incoming television signals locally at each television set and distributing decoding authorization data between television sets within the system such that decoding authorization data from a digital decoding arrangement associated with one television set can be transferred for operation in association with a digital decoding arrangement associated with another television set.
